(19) United States
(12) Patent Application Publication
(10) Pub. No.: US 2007/0133023 A1
(43) Pub. Date: Jun. 14, 2007

(54) Document For Determining Interference Scanning Frequencies

(75) Inventor: Thomas Wicker, Hemlock, NY (US)

Correspondence Address: Stephen B. Salai, Esq.;Harter, Secrest & Emery LLP, 1600 Bausch & Lomb Place, Rochester, NY, 14604-2711, US

(73) Assignee: Document Security Systems, Rochester, NY (US)

(21) Appl. No.: 11/610,323

(22) Filed: Dec. 13, 2006

Related U.S. Application Data
(63) Continuation of application No. PCT/US04/18580, filed on Jun. 14, 2004.

(51) Int. Cl. G06F 15/00

(52) U.S. Cl. 358/1.9

(57) ABSTRACT

A document containing lines printed at an interference scanning frequency which causes conventional scanning and copying devices to introduce distortions in a copy of the document and prevents color separating copies of the document. The document bears an image which has lines printed at a line frequency which is an interfering scanning frequency. A document containing an image which has several layers, each of which has lines printed at an angle and color which may be different from the other layers. At least one of the layers in document may be printed at an interfering scanning frequency. Also, the intersection between the lines of the layers may form a white space which has an interference scanning frequency by selecting appropriate angles between the lines. Interference scanning frequencies of a scanner may be determined by a document bearing a plurality of line frequencies, each line frequency being in a row and being printed at a variety of densities. An apparatus may be used to determine interference scanning frequencies of a scanning device by scanning a document with a plurality of images with a plurality of line frequencies and then determining which line frequencies create a scanned image with significant distortions, moiré patterns or density gains.

### CROSS-REFERENCE TO RELATED APPLICATIONS

This application is a continuation of PCT/2004/018580 which is hereby incorporated by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### FIELD OF INVENTION

This invention relates generally to color document protection methods and products, and more particularly to methods and products for printing and obtaining original documents that can be readily differentiated from copies made of those documents. The document protection methods and products also allow detection of an original document by a document reader.

### BACKGROUND OF THE INVENTION

Many methods and products have been developed, for example, to deter counterfeiting of valuable documents including art work, identification documents or financial instruments such as currency, so that unauthorized copies attempted to be made from those documents can be readily distinguished from the originals. Most of these methods and products involve preparing an original document by printing or lithography on high quality media such as silk, rice paper, and high contact rag paper. The printing of original documents may be done either in black-and-white (B&W) or in color, and if in color, either in spot color, colored backgrounds and/or multicolor printing. In the case of color, the tendency has been in the direction of using multiple colors for original documents for aesthetic value, for ease of recognition, and originally for protection from copying by conventional means. The common printing processes of valuable originals, whether in B&W or in color, are intaglio and gravure, among others. These and the other processes mentioned in this application are very well known in the art and will not be discussed in great detail.

Most of the useful examples in the prior art to deter counterfeiting and the like are intended to ensure that copies are produced either with a clear moiré pattern or with a “latent image” indicia which is invisible or nearly invisible to the naked eye on the original document. The term “latent image” is used here not in the photographic sense of an unseen image to be developed after processing by chemical reaction, but to indicate indicia that are printed on originals so as to be nearly invisible to the naked eye.

These and other developments in the prior art for purposes of providing document protection are disclosed in the patent literature, as for example, in U.S. Pat. No. 5,018,767 issued May 28, 1991; U.S. Pat. No. 5,193,853 issued Mar. 16, 1993; and U.S. Pat. No. 3,675,948 issued Jul. 11, 1972; and U.S. Pat. No. 4,143,967 issued Mar. 13, 1979, all to Ralph C. Wicker; in U.S. Pat. No. 4,227,720 issued Oct. 14, 1980 and U.S. Pat. No. 4,310,180 issued Jan. 12, 1982 both to William H. Mowry, et al, as well as U.S. Pat. No. 5,149,140 issued Sep. 22, 1992 to Mowry et al; and in U.S. Pat. No. 5,487,567 issued Jan. 30, 1996 to John R. Volpe. All of these patents disclose various means for providing methods and products to enable copies of documents to be distinguished from the originals, as for example, by a “large dot-small dot pattern”, a “close line-spaced pattern”, and images or indicia which are screen printed at minutely varied spaces and/or angles on the originals and are intended to produce a highly visible moiré pattern effect on the unauthorized copies. In this specification, the words “print”, “printed” and “printing” are used to refer to the making of an original document regardless of the techniques used, and the words “copy” and “copying” to refer to making copies from an original.

It is well known, however, that copier and computer scanner-printer technology has become even more sophisticated since the development of the prior art in document protection. The goal of copier technology, if not already achieved, has been, especially in desktop publishing and the like, to obtain copies as good as an original. “What you see is what you get” in color documents has become very achievable in copier and duplicator equipment including scanning input devices. Even desk-top computers have become sufficiently sophisticated in color reproduction, including color matching of copies to color standards such as the PANTONE.RTM. Color Matching System.

Many if not all of the document protection methods and products were developed before this very significant improvement in copier and computer reproduction technology, and have been found not be as effective in the newer color reproduction technology. This is especially the case on color copiers with a “photo” setting that intentionally copies a document in an “unsharp” focus so as to give the effect of a continuous tone image, the effect of which is to defeat the precise line variation between the copier scanner and the security pattern on the document original. These prior art techniques for document protection may not work as reliably against the many forms of copier/duplicator and computer scanner/output equipment now or soon to be available.

Most copying and scanning machines currently in use perform a geometric horizontal and vertical scan of documents to produce the image of the document. In order to accurately scan a colored document, such as a poster, for reproduction, several scans may be taken of the document at several angles, such as 90 degrees, 45 degrees and 0 degrees. Then the images produced from the scan may be provided to a software program, such as PHOTOSHOP™, and color separated to form separate images in each of the primary printing colors, e.g. cyan, yellow, magenta and black. Once the document has been color separated, a skilled artisan can readily identify defects in each color image separately, allowing them to defeat most security markings on the document, such as watermarkings and distortion producing patterns. After correcting the defects in the separate color images, the artisan can recombine the color images to produce a near identical copy of the original document.

Thus it has become imperative for purposes of document security and safety that further improvements in the area of document protection for color documents be found, especially where there is a need to prevent copying or duplicating of valuable originals and readily distinguishing the copies from the originals.

### BRIEF SUMMARY OF THE INVENTION

It is an object of the invention to overcome the above problems and provide enhanced security for documents.

A document carrying an image may comprise: a first image portion formed at a first color, the first image portion having a plurality of lines at a frequency of about 80, 95, 105, 245 or 200 lpi or any combination of lines dots or spots or images when printed in colors by themselves or incorporated into artwork pictures or indicia that would create distortions, moiré patterns, color shifts and density gain when said document is scanned by a scanning device.

A document carrying an image, the image may comprise: first lines having a first line frequency, a first angle and a first color; and second lines placed over the first lines and having a second line frequency, a second angle and a second color, wherein at least one of the first line frequency and the second line frequency are an interference scanning frequency.

A document carrying an image, the image may comprise: first lines having a first line frequency, a first angle and a first color; second lines placed over the first lines and having a second line frequency, a second angle and a second color; and third lines placed over the second lines and having a third line frequency, a third angle and a third color, wherein at least one of the first line frequency, the second line frequency and the third line frequency are an interference scanning frequency.

A document carrying an image, the image may comprise: first lines having a first line frequency, a first angle and a first color; second lines placed over the first lines and having a second line frequency, a second angle and a second color; third lines placed over the second lines and having a third line frequency, a third angle and a third color; and fourth lines placed over the third lines and having a fourth line frequency, a fourth angle and a fourth color, wherein at least one of the first line frequency, the second line frequency, the third line frequency and the fourth line frequency are an interference scanning frequency, or the combination of images create interference frequencies.

A document carrying an image, the image may comprise: first lines having a first line frequency, a first angle and a first color; and second lines placed over the first lines and having a second line frequency, a second angle and a second color, wherein white space is formed between the first lines and the second lines as a result of the intersection between the first lines and the second lines, the white space having at least one interference scanning frequency.

A document carrying an image, the image may comprise: first lines having a first line frequency, a first angle and a first color; second lines placed over the first lines and having a second line frequency, a second angle and a second color; and third lines placed over the second lines and having a third line frequency, a third angle and a third color, wherein white space is formed between the first lines, the second lines and the third lines as a result of the intersection between the first lines, the second lines and the third lines, the white space having at least one interference scanning frequency.

A document carrying an image, the image may comprise: first lines having a first line frequency, a first angle and a first color; second lines placed over the first lines and having a second line frequency, a second angle and a second color; third lines placed over the second lines and having a third line frequency, a third angle and a third color; and fourth lines placed over the third lines and having a fourth line frequency, a fourth angle and a fourth color, wherein white space is formed between the first lines, the second lines, the third lines, and the fourth lines as a result of the intersection between the first lines, the second lines, the third lines and the fourth lines, the white space having at least one interference scanning frequency.

A document carrying an image, the image may comprise: first lines having a first line frequency, a first angle and a first color; second lines placed over the first lines and having a second line frequency, a second angle and a second color; third lines placed over the second lines and having a third line frequency, a third angle and a third color; and fourth lines placed over the third lines and having a fourth line frequency, a fourth angle and a fourth color, wherein white space is formed between the first lines, the second lines, the third lines, and the fourth lines as a result of the intersection between the first lines, the second lines, the third lines and the fourth lines, the white space having at least one interference scanning frequency.

A document for determining interference scanning frequencies of a scanning device may comprise: a plurality of rows of images having a line frequency, each row having a line frequency which is different from line frequencies in other rows. In the document the line frequencies range from 50 lip to 400 lip. In the document, each row contains a plurality of blocks having lines printed at different densities.

An apparatus for determining interference frequencies of a scanning device may comprise: a processor configured to receive an image from a scanning device, and configured to compare the image from the scanning device with an original copy of the image, wherein the image has a plurality of image portions, each image portion having a different line frequency from other image portions, at least one line frequency being an interference frequency.

A method of determining interference frequencies in a scanning device may comprise: scanning a plurality of images and generating a plurality of scanned images, each image having a unique line frequency; comparing the scanned images to the images and determining if the scanned images contain distortions, moiré patterns, color shifts and density gain, wherein at least one image contains a line frequency which produces distortions, moiré patterns, color shifts and density gain.

A computer readable medium may carry instructions to cause a microprocessor to perform a method of determining interference frequencies in a scanning device comprising: scanning a plurality of images and generating a plurality of scanned images, each image having a unique line frequency; comparing the scanned images to the images and determining if the scanned images contain distortions, moiré patterns, color shifts and density gain, wherein at least one image contains a line frequency which produces distortions, moiré patterns, color shifts and density gain.

### BRIEF DESCRIPTION OF THE SEVERAL VIEWS OF THE DRAWINGS

The accompanying drawings, which are incorporated in and form a part of the specification, together with the description serve to explain the principles of the invention. In the drawings:

FIG. 1 illustrates a document having an image which was produced in accordance with the principles of the present invention;

FIG. 2 illustrates a magnification of the image of FIG. 1;

FIG. 3 illustrates another embodiment of a document which was produced in accordance with the principles of the present invention;

FIG. 4 illustrates a magnification of the image of FIG. 3;

FIG. 5 illustrates a further magnification of the image of FIG. 3;

FIG. 6 illustrates an exemplary test pattern 600 that may be used to determine interference frequencies of scanning and copying devices;

FIG. 7 illustrates an exemplary apparatus for determining interference scanning frequencies; and

FIG. 8 illustrates an exemplary flow diagram for a method of determining interference scanning frequencies.

### DETAILED DESCRIPTION OF THE INVENTION

Most copying and scanning equipment in use scan documents in a geometric horizontal and vertical scan and input images to a CCD array, which produces pixels used to make a digital image. The term scanning device is used hereafter to refer to any device which performs an optical scan to obtain an image of a document, including photocopying and scanning equipment. These devices have various interference scanning frequencies, i.e. line frequencies which do not scan accurately. These interference frequencies also may have one or more orders, fn, which also do not scan accurately. For example, typical scanning devices have interference frequencies of more than one first order moiré at 80, 95, 105, 245 and 200 lpi. The present invention produces a color image which is resistant to being color separated from a scan at any angle, making the document resistant to being copied accurately.

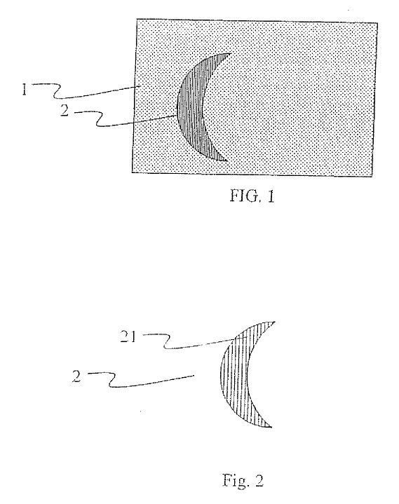

FIG. 1 illustrates a document 1 having an image 2 which was produced in accordance with the principals of this invention. Document 1 may be any type of printed document, including security notes, trading cards, etc. Image 2 is preferably formed by printing a plurality of lines having a color. The term “lines” as used in this application means solid lines, dots or spots or any other printing technique to form a line in an image.

FIG. 2 illustrates a magnification of image 2 to illustrate an exemplary layer of lines of image 2. A layer 21 having a first line density and a first angle of printing. First layer 21 is preferably printed at an interference frequency which produces a moiré effect when it is scanned by a conventional scanner or photocopier, such as a line frequency of about 80, 95, 105, 245 and 200 lpi (lines per inch). In this manner, moiré patterns do not appear in the original, while appearing in a copy of the original. Preferably, the density of each scanned color lines is substantially increased in the copy, e.g. by about 200% or up to about 400% or more, creating a distorted image.

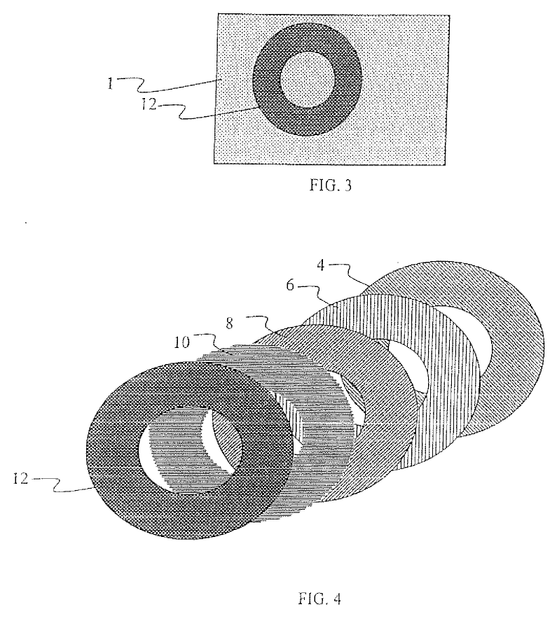

FIG. 3 illustrates a document 11 having a color image 12 which was produced in accordance with the principals of this invention. Document 14 may be any type of printed document, including security notes, trading cards, etc. Color image 12 is preferably formed by printing a plurality of lines having a color over each other at predetermined angles from each other. The composite image from the colored lines forms color image 12.

FIG. 4 illustrates a magnification of image 12 to illustrate four exemplary layers of lines of image 12. A first layer of lines 4 has a first line density and a first angle of printing. A second layer of lines 6 is placed over lines 4, the second layer has a second line density and a second angle of printing. The second angle of printing is preferably 5-25 degrees apart from the first angle of lines 4. A third layer of lines 8 is placed over lines 6 at a third line density and a third angle of printing. A fourth color may be printed with lines 10 at a fourth angle and fourth line density. The four base colors which are typically used for printing are cyan, yellow, magenta and black. The first to fourth line densities may be the same line density or different line densities depending on the desired color. Those of skill in the art will appreciate, that although image 12 is illustrated as using all four colors for purposes of illustrating the operation of the invention, the desired color of the image will dictate the relative proportions of the base colors to be used, which may result in as few as one color being used up to as many as all four colors being used with various densities.

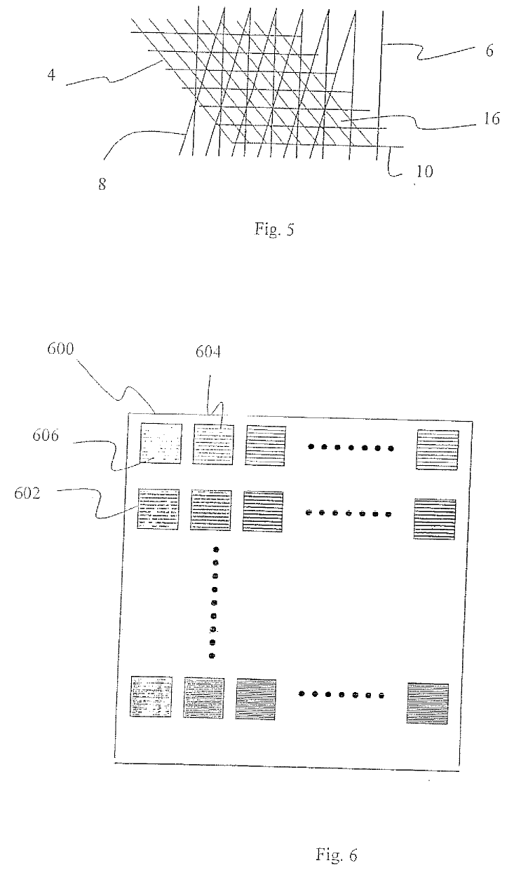

FIG. 5 illustrates a further magnification of image 2 to illustrate an exemplary interaction between the lines 4, 6, 8 and 10. As illustrated in FIG. 5 lines 4, 6, 8 and 10 are preferably printed at different angles and “white” spaces 16 are formed between the intersection of the lines. The combination of lines 4, 6, 8 and 10 and white spaces 16 form a frequency and are preferably produce an interference frequency of the scanning device. Preferably, the angle and frequency of lines 4, 6, 8 and 10 produce white space 16 which have a frequency which corresponds with an interference frequency of a scanning device. White spaces 16 may have any number of frequencies at various scan angles, including 0, 45 and 90 degrees, and may include more than one interference frequency and/or several orders of an interference frequency.

More particularly, interference frequencies may be introduced by printing one or more of lines 4, 6, 8 and 10 at an interfering frequency, or by placing one or more of lines 4, 6, 8 and 10 at an appropriate angle with respect to the other lines so that the white space formed has one or more interference frequencies. The former technique may be achieved by printing one or more of lines 4, 6, 8 and 10 at about 80, 95, 105, 245 and 200 lpi. The latter technique may be achieved by selecting angles for lines 4, 6, 8 and 10 which produce white space 16 at an interference frequency.

Using either technique, In this manner, although no moiré patterns will be seen in the original document. When a scanner or copier scans image 2, numerous moiré distortions are created due to the presence of line and/or white space frequencies at the interference frequencies. The image corruption preferably works at any scanning angle, including 0, 45, and 90 degree scans by having interfering frequencies at various scanning angles. The corruption also preferably increases, gets worse, with higher line frequencies since more interference frequencies may be utilized. Preferably, the interfering frequencies cause the scanner to increase or multiply the intensity of each of the colors in color separation (yellow, cyan, magenta and black) to have a density 300 to 700% their density on the original image 2. Thus, when a counterfeiter attempts to make a copy of an original document, the resulting copy preferably contains significant distortions which may even appear as a muddy blend of colors. Moreover, a typical scanning device also will not be able to provide an accurate image to a computer, effectively making it impossible to use a computer to perform a counterfeiting operation.

In an exemplary embodiment, lines 4 may be cyan at a density of 80 lip and an angle of 0 degrees, lines 6 may be yellow at a density of 245 lip and an angle of 105 degrees, lines 8 may be magenta at a density of 105 lip and an angle of 105 degrees and lines 10 may be black at a density of 95 lip and an angle of 90 degrees.

In another exemplary embodiment, lines 4 may be black at a frequency of 245 lpi and an angle of 0 degrees, lines 6 may be magenta at a frequency of 95 lpi and an angle of 15 degrees, lines 8 may be cyan at a frequency of 105 lip and an angle of 90 degrees and lines 10 may be yellow at a frequency of 80 lip and an angle of 105 degrees.

In another exemplary embodiment, only two colors may be used. For example, lines 4 may be black at a frequency of 245 lip and an angle of 0 degrees and lines 6 may be cyan at a frequency of 80 lip and an angle of 15 degrees.

In another exemplary embodiment, one or more of the colors may be printed in dots in between the lines. For example, lines 4 may be printed in cyan at a frequency of 105 lip at 0 degrees and a dot may be printed in between line 4 in magenta with a frequency of 285 lip at 0 degrees as well. White space is forced between lines 4 and the dots and also between the dots.

Preferably, the density of lines 6 and 7 are controlled by controlling the pitch (distance between lines), thickness of the lines 6 and 7, or by controlling the density of the medium, such as ink, used to print lines 6 and 7. The density of lines 6 and 7 may range from 5% to 95% depending on the colors selected for lines 6 and 7, the density of the medium, the thickness of the lines, and the desired appearance of image 2. In an exemplary embodiment, a density of 50% for each of lines 6 and 7 may be used, with a red color for line 6 and a green color for line 7. Also in an exemplary embodiment, lines 6 and 7 may be printed at a different angle than used to print background 3.

In an exemplary implementation of a security document using the principles illustrated in FIG. 3, lines 24 in background area 21 may have a frequency of at least 175 lines per inch and preferably of 300 lines per inch, and a line width of 0.0025 inches at a 45 degree angle, and lines 23 in image 14 may have a frequency between 100-133 lines per inch and preferably a frequency of 95 lines per inch at a 30 degree angle.

FIG. 6 illustrates an exemplary test pattern 600 that may be used to determine interference frequencies of scanning and copying devices. Test pattern 600 preferably has a plurality of rows 602 of different line frequencies ranging from about 50 lip to about 400 lip. Each row 602 preferably has a separate line frequency. Each row 602 preferably has a series of blocks 604 ranging in densities from about 20% to 80%. Preferably, when test pattern 600 is scanned, the scanner operator can view the scanned copy to determine which line frequencies provide the greatest distortion. The line frequencies which provide the greatest distortion may be used as the interference frequencies in a printing operation in accordance with the principles of the present invention. Accordingly, even if conventional scanning devices are modified in a manner which alters their current interference frequencies, newly created interference scanning frequencies may be readily identified.

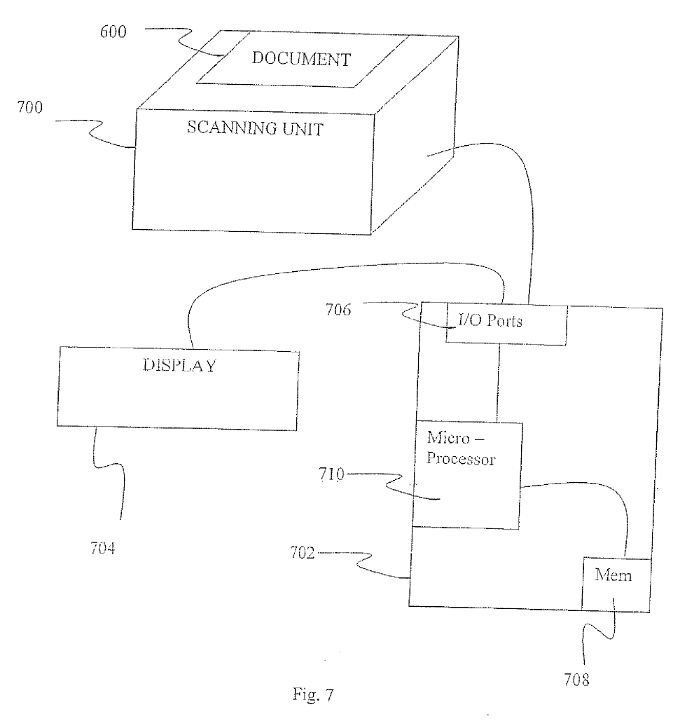

FIG. 7 illustrates an exemplary apparatus for determining interference scanning frequencies. As illustrated in FIG. 7, scanning device 700 preferably receives a document bearing test pattern 600, or any other suitable test pattern, and scans the document. The scanning device 700 may be any conventional type of scanning or photocopying unit, including scanning units capable of providing a digital image of a photograph or of providing an electronic word processor document from a text scan. Scanner 700 may be of the type suitable for use with photographic and text scanners, photocopiers, facsimiles. Scanner 700 preferably generates a scanned representation of a scan of document 600, such as a digital representation, and provides this information to a processor 702. Scanner 700 may contain one or more storage devices (not shown), such as a RAM, floppy disk drive, writeable CD drive, or the like, which may be used to store the scanned representation prior to being sent to the microprocessor.

Data of the scanned image is preferably provided to processor 702 through I/O ports 706, which may be connected to scanner 700 by a cable or a wireless connection or may be remotely located and connected through a suitable communication architecture, such as the internet, or telephone network. Processor 702 preferably contains the test pattern in a memory 708, which may be any type of memory such as a RAM, a ROM, a hard disk etc. Processor 702 also preferably contains a microprocessor 710 which is programmed to compare each line frequency and corresponding density in the original test pattern 600 recalled from memory 708 with the scanned image provided by scanner 700. Although I/O ports 706 and memory 708 are illustrated as being in separate units from microprocessor 710 for purposes of illustrating the invention, those of skill in the art will appreciate that I/O ports 706 and/or memory 708 may be integrally contained in microprocessor 710. Preferably, the microprocessor determines if any moiré patterns are produced by determining if there are distortions in the lines such as by determining if the direction(s) or orientation(s) of the lines are different in the copy than the test pattern 600 or if the lines in the copy are wavy or have a greater density than in the original. Line frequencies in the original which produce the greatest distortions in the scan copy, e.g. significant moiré patterns are produced, and/or line frequencies that cause the line density to increase by more than two times, are considered to be the interfering line frequencies. Microprocessor 710 may instruct display 704 to display a message indicating whether an interference scanning frequency has been found and/or may display the scanned image by itself or with the original image.

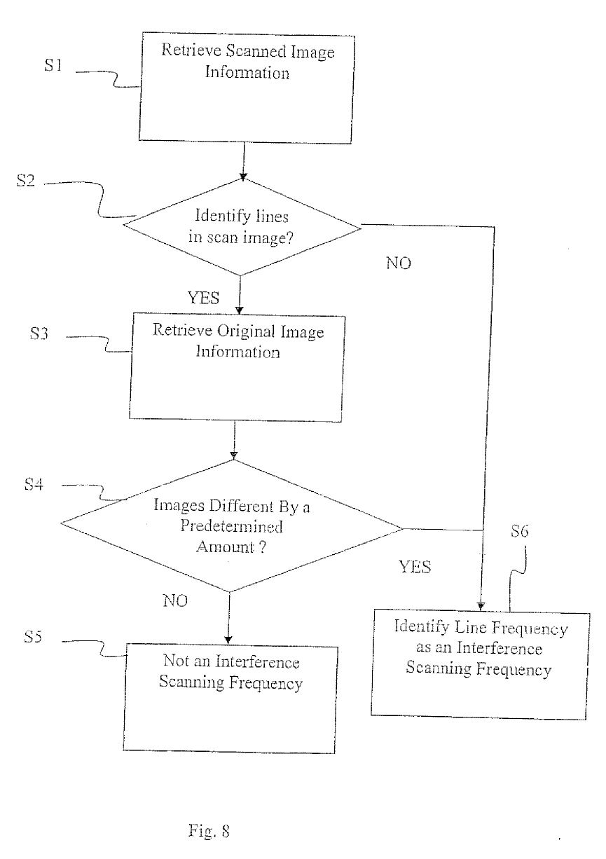

FIG. 8 illustrates an exemplary flow diagram for a method of determining interference scanning frequencies. As illustrated in FIG. 8, data indicative of a scanned image, which is preferably an image of a block 606 or a row 602, is received by processor 702 (step S1) which attempts to identify or discriminate lines in the scanned image (step S2). If lines cannot be discriminated in the scanned image, e.g. lines in a scanned block 606 cannot be determined, such as if significant distortions or moiré patterns are present in the scanned image, NO in step S2, processor 702 preferably determines the line frequency in the original image is an interference scanning frequency. If lines can be discriminated, YES in step S2, processor 702 preferably retrieves data indicative of the original image (step S3) and compares attributes of the original image to the scanned image (step S4). The compared attributes may include comparing the line frequency in the scanned image with the original, distortions of the lines in the scanned image (e.g. a straight line in the original being a wavy line in the scanned image), density gain of the lines, and/or convergence or divergences of the lines in the scanned image which are parallel in the original. IF the compared attributes are greater than a predetermined amount, e.g. if the density gain is about 200% or more, Yes in step S4, then the line frequency of the original image is identified as an interference scanning frequency. Otherwise, No in step S5, the line frequency is not identified as an interference scanning frequency.

The architecture illustrated in each of FIG. 7, may be entirely contained in a single device or multiple devices, and the functions associated with the architecture in FIG. 7 may be performed by programmable software. Moreover, the operations illustrated in FIG. 8 may be performed by programmable software on an internal or external memory (not shown) associated with microprocessor 710, such as a ROM or a RAM or any other memory. The software that performs the operations illustrated in FIG. 8 may be embodied in the form of data in a computer readable medium. A computer readable medium within the scope of this disclosure includes any medium, physical or metaphysical, which is capable of carrying information in a form which can be read by an appropriately configured computer or mobile communication device and associated peripheral devices of the computer or station, including, but not limited to: an optical readable/writeable disc, a magnetic disk, a readable/writeable card, a magnetic tape, an electrical transmission signal for wireline or wireless transmission or optical transmission of data using electrical and/or electromagnetic signals. The data associated with the programmable software, including any data to implement the method illustrated in FIG. 8 and data associated with the scanned image or the original image, may be in the form of packetized digital data and may configured for transmission over the internet.

Those of skill in the art will appreciate that a variety of images may be printed in accordance with the principles of the present invention to prevent unauthorized copying of those images. For example, the present invention may be used to print currency so that the currency could not be scanned and color separated to thwart counterfeiting efforts. Artwork, such as prints and posters, may also be printed in accordance with the principles of the present invention to thwart unauthorized copying, duplication or use of the artwork. The principles of the present invention may also be used to print security images, including latent security images, which may be used on a variety of documents, including identification cards, drivers licenses, currency, etc.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A document for determining interference scanning frequencies of a scanning device comprising:
a plurality of rows of images each image having a line frequency, the images in each row having a line frequency which is different from line frequencies of the images in other rows.

2. The document according to claim 1, wherein the line frequencies range from 50 lpi to 400 lip.

3. The document according to claim 1, wherein each row contains a plurality of blocks having lines printed at different densities.

4. The document according to claim 3 in which the densities range from about 20 to 80 percent.

5. An apparatus for determining interference frequencies of a scanning device comprising:
a processor configured to receive an image from a scanning device, and configured to compare the image from the scanning device with an original copy of the image,
wherein the processor compares a plurality of image portions to the original document, each image portion having a different line frequency from other image portions, at least one line frequency being an interference frequency.

6. The apparatus of claim 5 in which the processor compares to line frequencies and densities of the images.

7. The apparatus of claim 5 in which the processor determines whether any moiré patterns are present.

8. The apparatus of claim 7 in which the processor determines whether the directions or orientations of the lines in the image are different from the original.

9. A method of determining interference frequencies in a scanning device comprising:
scanning a plurality of images and generating a plurality of scanned images, each image having a unique line frequency;
comparing the scanned images to the images and determining if the scanned images contain distortions, moiré patterns, color shifts and density gain,
wherein at least one image contains a line frequency which produces distortions, moiré patterns, color shifts and density gain.

10. The method of claim 9 in which comparing the scanned images comprises comparing one or more of line frequency, distortions, density gains, convergence and divergence.

11. A computer readable medium carrying instructions to cause a microprocessor to perform a method of determining interference frequencies in a scanning device comprising:
scanning a plurality of images and generating a plurality of scanned images, each image having a unique line frequency;
comparing the scanned images to the images and determining if the scanned images contain distortions, moiré patterns, color shifts and density gain,
wherein at least one image contains a line frequency which produces distortions, moiré patterns, color shifts and density gain.
